(19) United States
(12) Patent Application Publication
(10) Pub. No.: US 2012/0054813 A1
(43) Pub. Date: Mar. 1, 2012

(54) Immersive interactive publication

(75) Inventor: Christopher Carmichael, Lawna Miguel, CA (US)

(73) Assignee: UBIQUITY HOLDINGS, San Juan Capistrano, CA (US)

(21) Appl. No.: 13/184,687

(22) Filed: Jul. 18, 2011

Related U.S. Application Data
(60) Provisional application No. 61/366,123, filed on Jul. 20, 2010.

(51) Int. Cl. H04N 21/40

(52) U.S. Cl. 725/110

(57) ABSTRACT

A movie book which binds together movies and books along with social networks associated with words of the book. The book is viewed on a display screen of a computer, with said viewing comprising both content interspersed with both pictures and video, and where at least plural words of the book, and at least plural of the pictures and video are linked to additional content, and where said additional content includes interactive media. One of those media links is a link to a social network site related to a content of the interactive book, and which is shown on a same display screen at the same time is showing said interactive book. The user can also change the different parts of the book in combination with the social media.

This application claims priority from provisional application No. 61/366,123, filed Jul. 20, 2010, the entire contents of which are herewith Incorporated by reference.

### BACKGROUND

Many different systems are known in which files can be downloaded and played on a client computer that receives the information from some source. Exemplary client computers that can play these files may include a general-purpose computer, or a telephone such as an iPhone. PDAs such as an Ipad™, or others may also be used. In addition, there are many special-purpose devices, such as DVD players and the Amazon Kindle book reader that can read electronic information of this type.

These devices allow books to be read and videos such as DVDs to be viewed.

According to industry sources, e-book sales will reach $2.7 billion by 2013, and are growing at an average growth rate of over 72%. As of the writing of this application in 2011, approximately a fifth of all consumers already have abandoned paper books in favor of e books. The demographics vary widely among the age groups, with the younger age group being unsurprisingly more likely to be willing to adopt e-books.

As of the writing of this application, e-books can be read on a number of different platforms including Amazon's “Kindle”; the Sony e-book reader, as well as Apple's iPad, certain Android tables, Barnes & Noble's “Nook” as well as many other different platforms. The different book reading platforms often read different forms of books, with the most popular including mobi, epub, lit and PDF. Some of book readers will read multiple different formats, but most do not read all of them.

At the same time, physical media for holding electronic information, of all sorts, is on the decline. While a decade ago, people routinely purchased CDs and DVDs, the more recent trend is for all of this information to be received digitally without a specific physical media. The so-called crossover point will be reached when the amount of media received digitally exceeds the number of physical media that is sold or distributed.

A number of different digital publishing suites are known. Adobe makes a digital publishing suite that allows combining different forms of information into a specified form. Adobe's Flash platform allows application content and video to be combined together. Different kinds of content production systems, including DVD lab Pro 2, Muvee reveal, DVD Architect Studio, DVD Movie Factor, DVD Studio, My DVD, and power producer, allow creation of content for a DVD.

The format/channel known as “Ultraviolet” allows distributing information to users in various different forms.

### SUMMARY

The present application describes a device that forms the intersection between a number of different market trends including digital video e-book consumption; tablet and other portable device availability; the evolution of the publishing and video business to a digital business, along with the wide adoption of interactive Internet systems such as social networking, blogs, and the like.

According to an application, each of digital media, interactive Internet, are combined into a single form of multimedia. According to embodiments, a new format is described that is interactive, data rich, socially connected, and includes both low definition information such as e-books along with higher definition information such as Blu-ray and along with different kinds of interfaces to social networking information about subjects related to the media. In addition, this combines a collaborative operation, where users can add their own annotations both those which will be reviewed by them and their friends, as well as publicly available annotations.

An embodiment describes a system, with an electronic media player, that has a display screen, showing an interactive book, of the type which includes both content interspersed with both pictures and video, and where at least plural words of the book, and at least take plural of the pictures and video are linked to additional content, and where said additional content includes interactive media, and wherein at least one of said interactive media includes a link to a social network site related to a content of the interactive book, and which is shown on a same display screen at the same time is showing said interactive book.

Another embodiment describes that users of the book can change aspects of the book, including the specific social media links, and where those aspects of the book can be changed both for themselves and for others.

### BRIEF DESCRIPTION OF THE DRAWINGS

In the Drawings:

FIG. 1 shows a block diagram of the movie book system; and

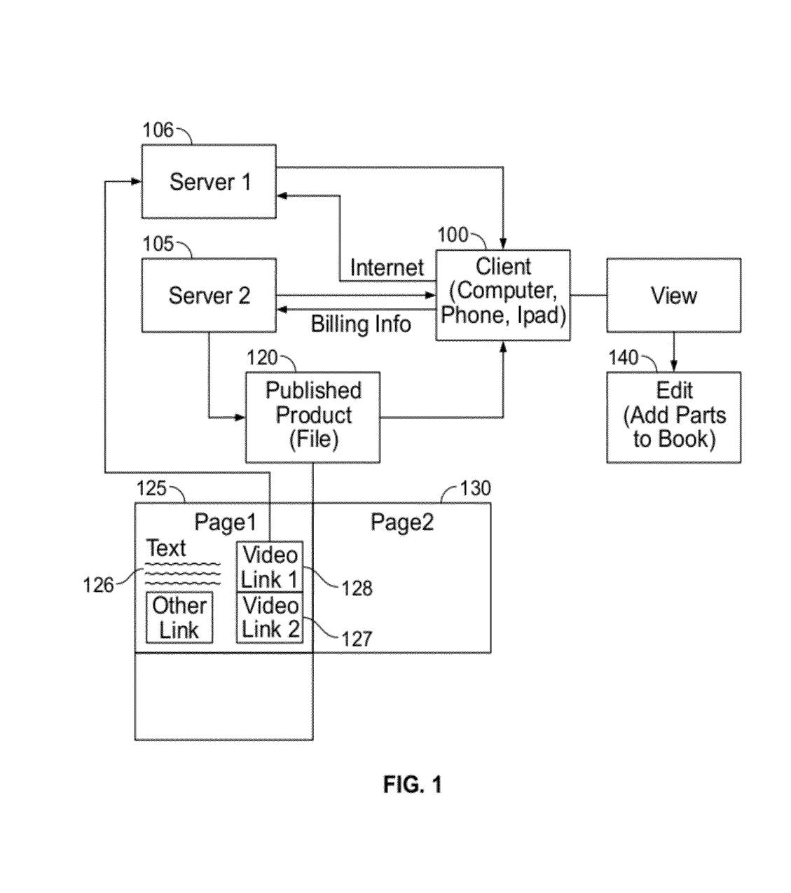

FIG. 2 illustrates how the different media can be used together to form an interactive book.

### DETAILED DESCRIPTION

The present application describes a new form of multimedia that combines different forms of multimedia together into a “movie book”. A client computer such as an iPAD™ may be used to read downloaded or preloaded material. However, the computer that is used can be any kind of portable or standalone computer, either single-purpose or multiple purpose computer. The “movie book” mixes electronic books with movies or videos about the book, with internet, blogs, social networking and any other form of interactive or network accessible items. An embodiment allows bringing to life these items by combining multiple different forms of the information which are all about the same item, for example about the same title.

For example, a book about Harry Potter may be a combination of:

a book, e.g., Harry Potter X.

a movie about the book, e.g, telling the story, the making of the movie, biographies, summaries or any other information about the book.

social networks such as Facebook pages or fan pages about Harry Potter, and along with any other social network, including any information from social networks. One embodiment allows the user to take an interactive action as part of the social network. For example, the user can indicate a “like” In this way, this becomes a rich multimedia experience, with information, from a plurality of different forms, about the specific title. In essence, this brings the title “to life”.

According to another embodiment described herein, the multimedia is also collaborative in the sense that the user can add their own annotations. Therefore, in addition to the user being able to access items like the social network, the user can also add their own multimedia items including their own fan pages on the social network, for example. By allowing the user to add their own information to the book, the book becomes personalized to them, and can also be shared with friends, in which case the book becomes personalized to the circle of friends reviewing the book.

The client 100 communicates over the Internet with any of a number of servers, shown as 105 and 106. While this shows only two different servers, many different servers can be used. The server 105 may be the provider of the published product shown as 120. The published product can be a single file or a number of files. This can include a number of different formats of information. For example, the file may be in the form of an e-book, or any type of publishing product such as a e-magazine, comic books, newspapers, e-newsletter, product manuals, brochures, etc.

The published product 120 has a number of different pages of information as conventional for a book of this type. The product has pages 125, 130, where each page can be a page of information to be read by a user. Each page has lines of text making up the book. The lines 126 are intertwined with different kinds of links about the book. The links can be to local parts of the file, including video and graphics and/or music that are part of the file. These local links are shown generically as 127, and can be to any part of the file. The links 128 can be to other sites on the internet that show or have information about the book. For example, the links can be to social networking, live video chat, blogs, or music or video that are hosted on a remote server 106 accessible over the internet.

As described above, customization is possible. Prior to initial customization, however, the links may be to the most popular social network, chat, blogs, or the like, and the links can be updated as the popularity changes. For example, the most popular links may be updated once per week or other amount or may be dynamically updated whenever the favorite changes and the movie book is connected to the network.

In operation, the user can read the text such as 126, and the text may be embedded with links to either local content or remote content of the types above. For example, the links can be related to the content (such as Harry Potter X in the example given above) but to many different sources including social network sites such as Facebook and Twitter, to Amazon in order to purchase books and other items, and to any other forms. The text can be standard ASCII text formatted according to HTML tags or using PDF style formatting, but can also be other forms of text including text in images or vectors or any other format. The text can be colored.

In the case of a comic book, the text 126 is itself intertwined with picture or video information. For example, a comic book, or hybrid comic book may be used that includes existing video and animation techniques but should also include 3D applications and holographic features as well.

The above describes downloading a published product such as 120 which already includes information therein. However, in another embodiment, the published product 120 may be an existing book of a conventional form, and/or something contextually related to that book, such as a movie that came from that book, or another book or another media of any kind that uses the same or related characters from the book, e.,g a “spinoff”. The book and the video can be introduced together in order to bring the elements to life, such as a paper book introduced with a video movie which can be seen on the same screen and link back and forth together with one another.

The music, e.g., the soundtrack associated with the book or movie can also be included. For example, different parts of the soundtrack from the movie can be played automatically as the user reads the book, assuming that the user has not overridden that feature.

This can also be used as a selling tool. For example, a user can buy a book in “movie book” format. The book may include certain kinds of public videos and pictures, for example movie trailers for teasers. However, it can also include links that enable the user to buy more parts of the book that provide a richer multimedia experience. For example the user can get links to purchase a copy of the entire movie when they view the trailer. The user can get certain sounds and music, but can have a link that enables them to buy the entire soundtrack. In this way, the user can purchase a bare-bones version of the book, and can purchase additional portions that make the book more lifelike. Any of these parts can be dynamically downloaded.

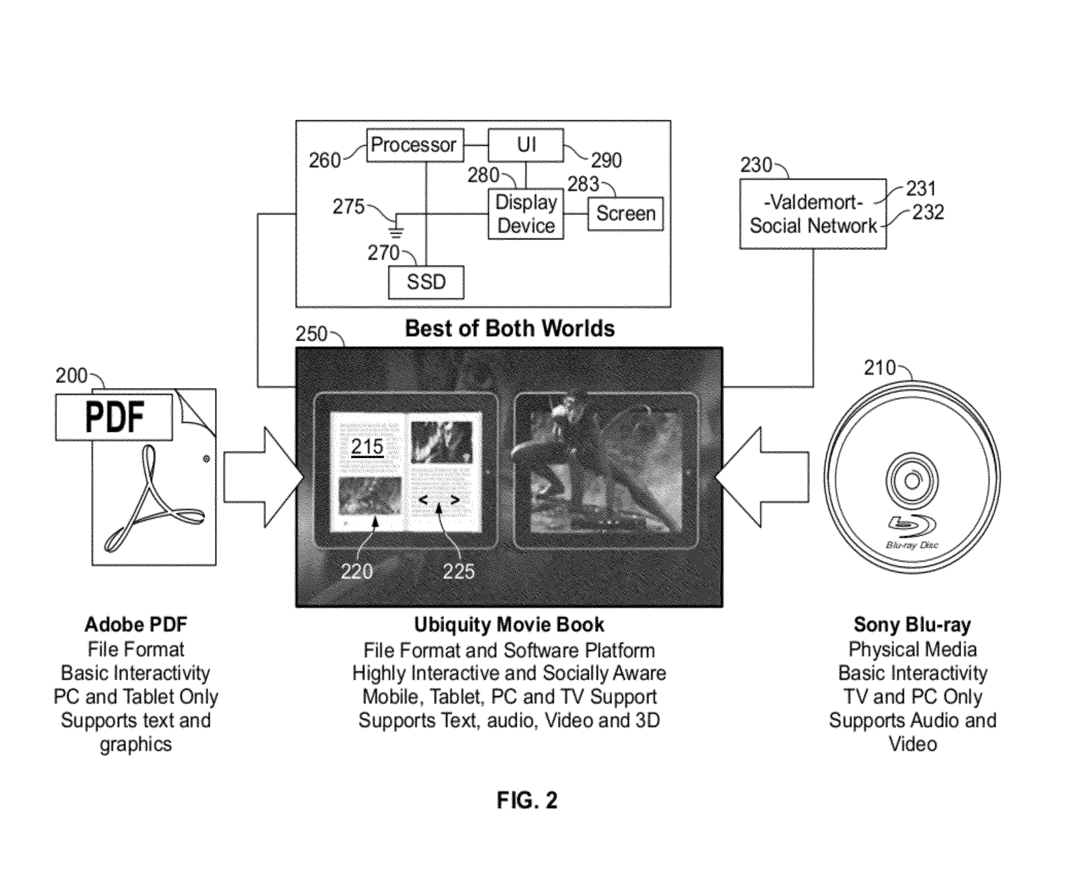

FIG. 2 illustrates how the multiple forms, together, can both be displayed on a screen of a portable computer, e.g., an iphone or ipad. The ebook portion 200, here shown in PDF form, is combined with a multimedia format device 210 here shown in bluray form. In one embodiment, the player 250 can be a tablet type device. The tablet may include a processor 260 connected to a nonvolatile memory which may be solid state drive type memory 270, driven by a battery 275 and producing output over a display driver 280 that produces output on the display screen 285. The user interface as shown as 290 may be any conventional kind of input device including wireless, wired, or any other kind of input device.

The solid-state device 270 stores the different parts of the movie book, which may include PDF or e-book type “text” associated with multimedia devices of the type described herein. In one embodiment, this may be stored in the form of XML links, where the different words of text may be associated with XML links to the different additional information.

Views of the movie book 210 shows text 215 interspersed with different clips shown as 220 that are from the video device. In addition, different places within the book include different links shown as 225. Each of those links may be selected to carry out a function. As described herein, the links and the pictures can be selected by rolling over the picture or over the link. For example, when the link represents a character or a subject, rolling over the link may bring up the menu shown in 230 that shows the subject 231, and different possible things that one can do with the subject including the social network 232, which can be for example Facebook or the like. This may be for example the official fan page 4 of the specific movie or the specific book in the social network. It can also be a link to twitter or any other type system. By following the Twitter link, updates from Twitter can become part of the book. In one embodiment, different fans can add annotations, and users can vote on those annotations. For example, once an annotation gets 10,000 (or some other number of) votes, it may become part of the official annotation, and pushed to all users who have opted in to receive official annotations. Annotations can be anything, including links to other social websites or blogs, links to videos, pictures, or any other subject matter. This encourages people to become twitter followers of the page, since they may receive automatically updates to the movie book.

Any of the collaborative annotation authoring, real-time content and media, described above can be automatically pushed to books of others, thereby updating the complete media experience. One form of the collaborative annotation allows users to enter their own fan pages or other social network pages which are then substituted within the format for the any original comparable pages, and may also be sent as a collaborative format to other users.

Another embodiment may allow the users to themselves annotate the published product.

For example, a user can edit the parts of the book at 140, to add parts or the like. One embodiment includes collaboration that allows a user to write their own ending, their own chapter; their own videos or animations and graphics for use by other users. As examples of users own videos, may include videos of events about the subject of the media, or recreations such as “cosplay” about the subject of the media. Users can forward it on to other users to read or experience. Those other users can also annotate the book, thus making the book interactive with the users own personalization. The book as annotated itself becomes a form of social network. In this sense, the movie book is socially aware, since it allows companion browsing, as well as collaborative authorship, as well as other social features.

A user can also write a book in this way, and send it through their social network. Members of the social network can then either annotate the book, or comment on the book, or add to the book. When different users are collaborating on the book, it can be developed by hundreds of people chapter by chapter, like a never ending story. Part of the story can also include links to different sites such as social networking sites. For example, users may tend to bring parts of the story to life by linking to a site such as social networking site which may include different kinds of visual imagery which may go with the story.

This forms a new platform. This may allow, for example, media owners to go back to existing inventory and turn the book into an interactive, immersive, streaming media piece, where users can do multiple tasks. Users can read the book as conventional, and can also watch streamed video. The book may include pictures, and by rolling over a picture, the picture actually animates to include information that can be downloaded information or information that is included as part of the picture. Users can use voice over narration, either that has been previously presented, or narration that is added by a specific user. The book may include videos associated with different parts of the book. Those videos can be played, fast forwarded and rewound. Moreover, different sections in the video may be automatically bookmarked to different specific sections of the video.

This system allows the user to use the same piece of multimedia in a number of different ways. The book itself can be read as normal, or the movie itself can be played as normal. The book may include pictures, which can be seen as part of the book. However, the different parts of the book may be added together to use different parts of the multimedia. As one example, when the user rolls over a picture, that picture may “come to life”, by showing some kind of multimedia associated with the picture which may be local multimedia, or may be based on a link to a remote multimedia which can be a remotely supplied video, or a remotely supplied social network site content. Different pictures and other links can add voice over narration. According to an embodiment, the user can turn pages and hear different kinds of music.

The book becomes live and interactive. Users can play videos and pause and rewind the sorts for study and you can have a new experience in reading it.

Another embodiment combines the digital book with 3D animation motion graphics that have all the elements from the theatre or TV; including all the elements of multimedia, and intuitive interactive media pieces. This allows users to read pages and look at video or digital streaming pieces that are spread throughout the presentation. Another embodiment opens up the piece as a 3D holographic piece presentation.

An embodiment uses this in a comic book in which users mix and connect to all the ultimate media pieces.

One embodiment infuses the technology with roll over search tools. The rollover search tools can pop up different information when a user selects or rolls over something that has associated information there with. For example, rolling over a picture may pop up search results for that picture. Rolling over keywords may print out search results for those keywords.

In the embodiments, the rollover can occur when the user hesitates their mouse for more than one second over the item. The pop-up can be in the form of a screen tip, or can be a special window that opens but automatically closes when the user moves off of the key word unless the mover user moves off the keyword directly to the special window that has opened.

The rollover search can provide information such as maps or diagrams of a simulated world described by the movie book, or can search for particular content.

Embodiments allow adding to a book or other published product, a voice over, roll over functions, e-commerce, tutorials, coloring via touch screen, commercials, animations, games, searches, key works linked to definitions and other information, projection, networking groups for on line collaboration, drag and drop, motion graphics, touch screen, sound effects, user groups, including 3D applications and holographic features as well.

The published products can include cover books, magazines, websites, movies, videos, blogs, cell phone content and can be used on any digital device.

An example of how this can be used: Harry Potter came out with a series of books and now there have been several movies made after the books. The books and movies can be linked together according to this system. Fan pages and blogs and social network pages can be linked.

Other embodiments are contemplated.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other forms of sending and receiving information can be used, and other kinds of social networks are contemplated. Also, the annotations can be any kind of annotations, in any form, including any kind of media.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system, comprising:
an electronic media player, comprising:
a display screen, showing an interactive book, of the type which includes both content interspersed with both pictures and video, and where at least plural words of the book, and at least plural of the pictures and video are linked to additional content, and where said additional content includes interactive media,
wherein at least one of said interactive media includes a link to a social network site related to a content of the interactive book, and which is shown on a same display screen at the same time is showing said interactive book.

2. The system as in claim 1, wherein said electronic media player includes a link to the Internet.

3. The system as in claim 2, wherein said link to the social network site is personalized according to a user's own personalization.

4. The system as in claim 3, wherein said link to the Internet is used to share the user's own personalization with other users, so that said other users see the personalization.

5. The system as in claim 2, wherein said link to the social network comprises a most popular link among other users, which is updated over said link to the Internet to include different links at different times which changes depending on popularity of the links.

6. The system as in claim 2, further comprising an interactive link which comprises a link to a video associated with words of the book, where it at least portions of the video are automatically displayed on the screen when the words of the book are rolled over by a user.

7. The system as in claim 3, further comprising allowing a video created by the user to be associated with words of the book, and allowing sharing said video created by the user with other users who are reading the same book, where said video created by the user is associated with said words of the book for said other users.

8. The system as in claim 2, where users of the book can change aspects of the book, both for themselves and for others.

9. A system as in claim 8, wherein the social network that is represented by said link keeps track of aspects of the book which have been changed, and allows users to indicate whether they like the change.

10. A system as in claim 9, wherein when more than a specified number of users like the change, the change is automatically sent to more users you on those who have indicated that they like the change.

11. A method, comprising:
viewing an electronic interactive book on a display screen of a computer,
said viewing comprising both content interspersed with both pictures and video, and where at least plural words of the book, and at least plural of the pictures and video are linked to additional content, and where said additional content includes interactive media,
wherein at least one of said interactive media includes a link to a social network site related to a content of the interactive book, and which is shown on a same display screen at the same time is showing said interactive book.

12. The method as in claim 11, further comprising linking from said electronic book to the internet.

13. The method as in claim 12, wherein said link to the social network site is personalized according to a user's own personalization.

14. The method as in claim 12, wherein said link to the Internet is used to share a user's personalization with other users, so that said other users see the personalization.

15. The method as in claim 11, wherein said link to the social network comprises a most popular link among multiple other users, which is updated over said link to the Internet to include different links at different times which changes depending on popularity of the links.

16. The method as in claim 12, further comprising an interactive link to a video associated with words of the book, where it at least portions of the video are automatically displayed on the screen when the words of the book are rolled over by a user.

17. The method as in claim 13, further comprising allowing a video created by the user to be associated with words of the book, and allowing sharing said video created by the user with other users who are reading the same book, where said video created by the user is associated with said words of the book for said other users.

18. The method as in claim 12, where users of the book can change aspects of the book, both for themselves and for others.

19. A method as in claim 18, wherein the social network that is represented by said link keeps track of aspects of the book which have been changed, and allows users to indicate whether they like the change.

20. A method as in claim 19, wherein when more than a specified number of users like the change, the change is automatically sent to more users you on those who have indicated that they like the change.
